(19) United States
(12) Patent Application Publication
(10) Pub. No.: US 2004/0150784 A1
(43) Pub. Date: Aug. 5, 2004

(54) Glasses frame structure

(76) Inventor: Titan Lin, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 10/357,455

(22) Filed: Feb. 4, 2003

(51) Int. Cl. G02C 1/00

(52) U.S. Cl. 351/41

(57) ABSTRACT

A glasses frame structure has a frame body, a pair of temples and a pair of lenses. A nose pad is further mounted on an interior surface of the frame body at a location corresponding to a wearer's nose. A cavity is formed on the frame body above the nose pad. The glasses frame of the invention, which is placed in position by uniformly distributing the stress over the wearer's nose in spite of skin excretions on the nose, thereby provides improved performance and long-term wearing comfort.

### BACKGROUND OF THE INVENTION

1. Field of the Invention

The invention relates to a glasses frame structure and, more specifically, a glasses frame structure with an improved nose pad construction.

2. Description of the Related Art

Two critical factors must be considered for long-term wear of a glasses frame: comfort, and stable positioning of the glasses frame.

The glasses frame contacts the wearer's face via a nose pad and a pair of temples. Usually, discomfort during wear results from a non-uniform stress distribution of the glasses frame over the wearer's nose through the nose pad. Therefore, reduction of the stress exerted by the nose pad on the wearer's nose may improve the comfort. However, a sufficient clasping force of the nose pad on the wearer's nose is required for stable positioning of the glasses frame, which be in may conflict with a design that first considers the wearer's comfort.

FIG. 1 and FIG. 2 show a conventional glasses frame made of plastic. The conventional glasses frame includes a frame body 10, a pair of temples 11 and a pair of lenses 12. A nose pad 13 is mounted on the frame body 10 between the lenses 12. More particularly, the nose pad 13 is firmly mounted on a rigid plug 14 projected from the frame body 10, as shown in FIG. 3. By means of the attachment A of the nose pad 13 on a wearer's nose and the hang B of the temples 11 on the wearer's ears, the wearer can stably wear the glasses frame.

However, the conventional glasses frame has the following disadvantages.

1. The weight of the glasses frame is concentrated on the rigid plug 14. The wearer therefore may feel uncomfortable when wearing the glasses frame.

2. The friction force of the nose pad is not enough to be maintained in position on the wearer's nose.

3. The wearer's nose cannot easily hold the glasses frame in position.

### SUMMARY OF INVENTION

It is therefore one object of the invention to provide a glasses frame that uniformly distributes the weight of the glasses frame on the temples and the nose pad. Furthermore, a nose pad that better complies with the wearer's nose to more uniformly distribute the weight of the glasses frame on the wearer's nose is provided to hold the frame body at a proper location on the wearer's nose despite skin excretion such as sweats or skin oil. Therefore, the wearer can comfortably wear the glasses frame.

In order to achieve the above and other objectives, the invention provides a glasses frame that includes a frame body, a pair of temples and a pair of lenses. The lenses are fixed within the frame body. The temples are respectively connected with side ends of the frame body. A nose pad is further mounted on the frame body at a location corresponding to the wearer's nose.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a side view illustrating a conventional glasses frame placed on a wearer's face;

FIG. 2 is a top view illustrating a conventional glasses frame placed on a wearer's face;

FIG. 3 is a perspective view of a nose pad firmly mounted on a rigid plug projected from a frame body of a conventional glasses frame;

FIG. 4 is a front view illustrating a nose pad of a glasses frame placed on the wearer's nose according to one embodiment of the invention;

FIG. 5 is a side view illustrating a nose pad of a glasses frame placed on the wearer's nose according to one embodiment of the invention;

FIG. 6 is a partially exploded view of a glasses frame according to one embodiment of the invention;

FIG. 7 is a side view illustrating a nose pad mounted on a frame body of a glasses frame according to one embodiment of the invention;

FIG. 8 is a side view of a glasses frame worn by a wearer according to one embodiment of the invention; and

FIG. 9 is a schematic view illustrating a stress exerted by the glasses frame on the wearer according to one embodiment of the invention.

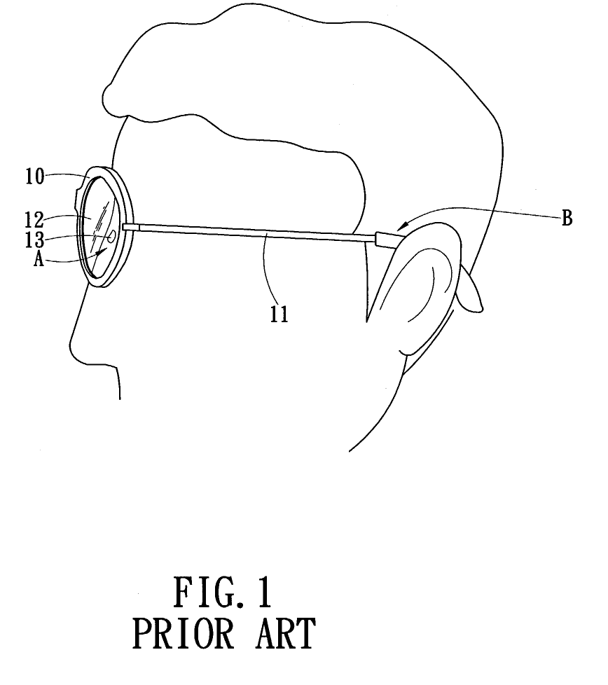

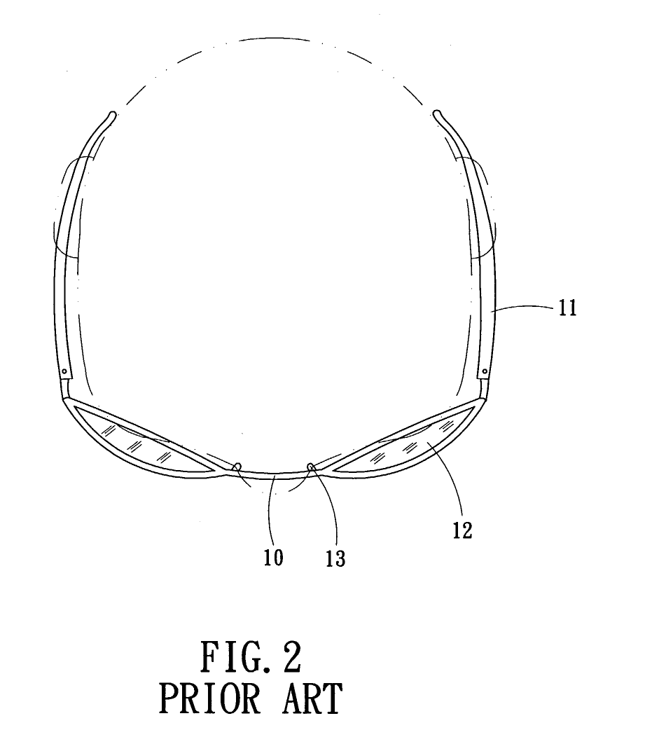

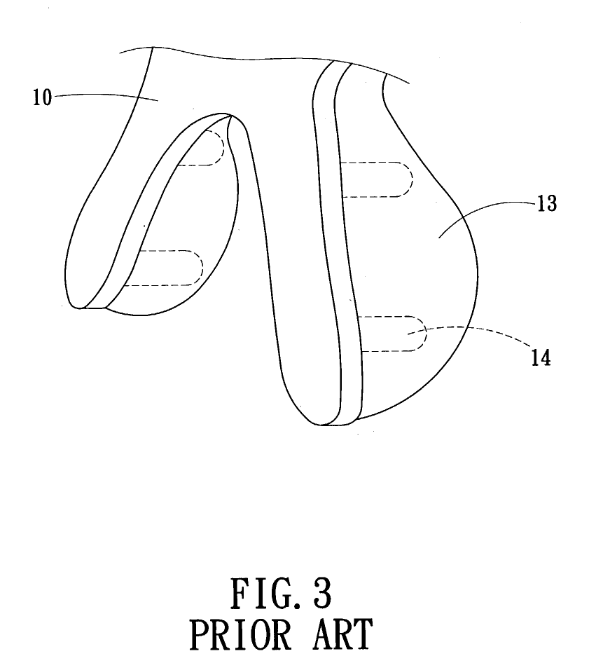

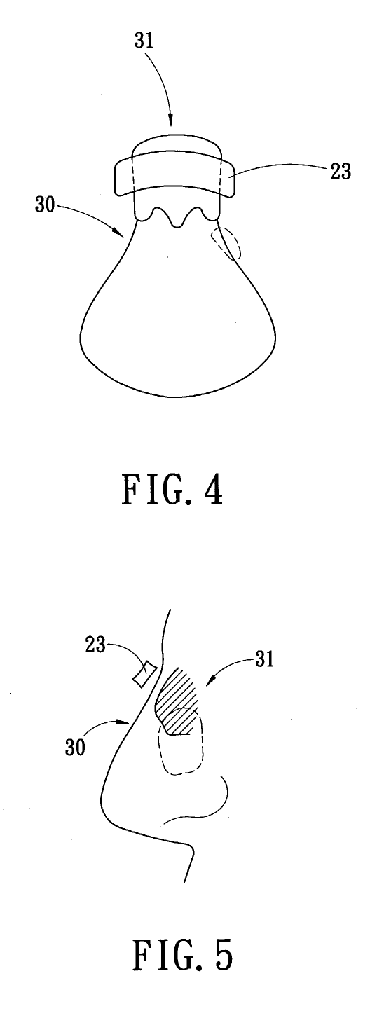

### DETAILED DESCRIPTION OF THE EMBODIMENTS

Wherever possible in the following description, like reference numerals will refer to like elements and parts unless otherwise illustrated.

The problem of a glasses frame being mobile on a wearer's nose can be solved by uniformly distributing the weight of the glasses frame over a nose pad and a pair of temples of the glasses frame. Furthermore, the nose pad can be made more compliant with the profile of the wearer's nose so that the nose pad of the glasses frame does not slide down along the wearer's nose due to gravity.

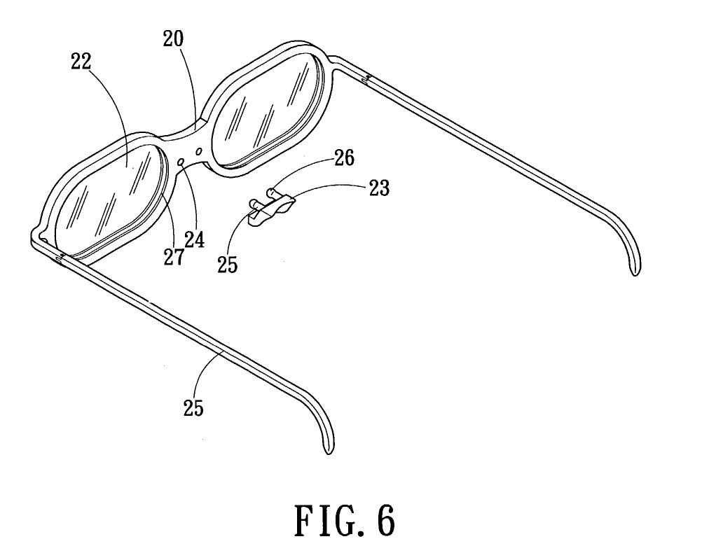

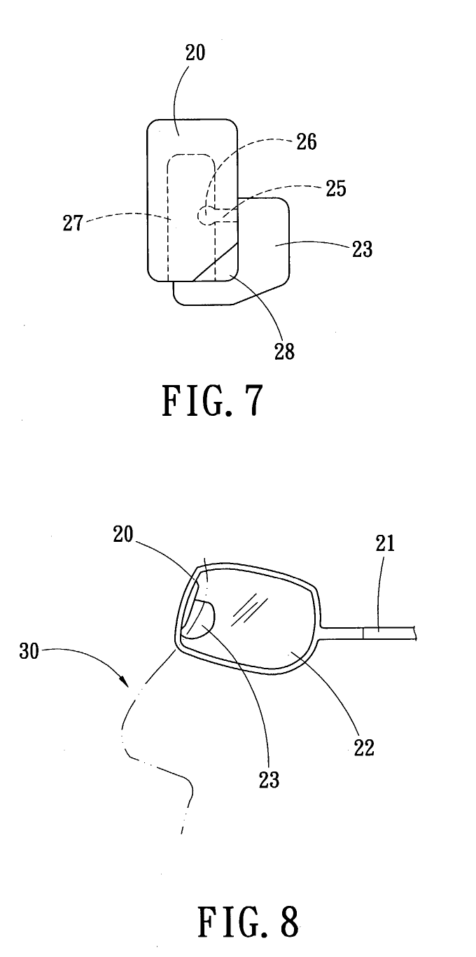

Referring to FIGS. 6-8, the invention provides a glasses frame structure, and more particularly a plastic glasses frame structure, which includes a frame body 20, a pair of temples 21 and a pair of lenses 22. The lenses 22 are fixed within the frame body 20. The temples 21 are respectively pivotally connected with side ends of the frame body 20 to allow opening and folding operations. The frame body 20, the temples 21 and the lenses 22 may be constructed by, for example, conventional techniques known in the art.

A nose pad 23 is further mounted on an interior surface of the frame body 20 at a location corresponding-to the wearer's nose. The material used to make the nose pad 23 is, preferably, a flexible material. The shape of the nose pad is not particularly restricted as long as it complies with the profile of the wearer's nose. A plurality of securing holes 24 is formed through the frame body 20 between the lenses 22. The nose pad 23 has a plurality of projections 25 each respectively fitting the securing holes 24. T he nose pad 23 is thereby firmly mounted to the frame body 20.

Furthermore, each of the projections 25 has a boss 26. When the lenses 22 are mounted in corresponding grooves 27 of the frame body 20, the bosses 26 of the projections 25 are clasped between the lenses 22 and the frame body 20.

A cavity 28 is formed on the frame body 20 above the nose pad 23, which contributes to a higher compliance of the frame body 20 with the wearer's nose and a more uniform distribution of the weight of the glasses frame on the wearer's nose. The glasses frame structure of the invention is thereby achieved.

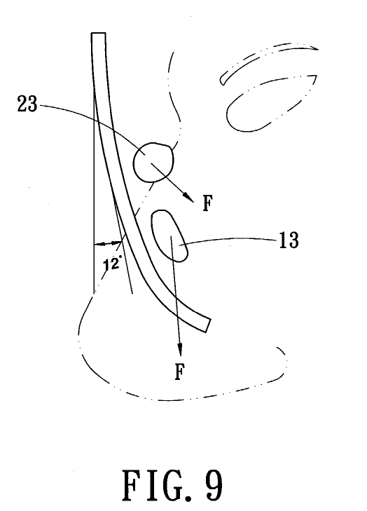

As illustrated in FIG. 9, due to the angle at which the glasses frame is worn, the stress exerted on the bridge of the wearer's nose differs from that on the sides of the wearer's nose. Typically, the bridge of the wearer's nose can entirely bear the stress exerted by the nose pad, while the sides of the wearer's cannot. Therefore, the pair of temples is needed to stop the glasses frame from sliding downward when it is worn.

The nose pad 23 of the invention uniformly distributes the stress over the wearer's nose by highly complying with the profile of the wearer's nose; Therefore, the glasses frame of the invention can be maintained in position despite skin excretions such as sweat or skin oil on the nose, which provides an improved performance and comfort in wearing.

As described above, the glasses frame of the invention, being maintained in position by uniformly distributing the stress over the wearer's nose, in spite of skin excretion on the nose, solves the problems of the prior art and provides improved performance and comfort.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A glasses frame structure, comprising:
a frame body, provided with a nose pad mounted on an interior surface of the frame body at a location corresponding to a wearer's nose;
a pair of temples, respectively pivotally connected with side ends of the frame body; and
a pair of lenses, fixed within the frame body.

2. The glasses frame structure of claim 1, wherein a plurality of securing holes are formed through the frame body between the lenses, and a plurality of projections are formed on the nose pad to respectively fit the securing holes, the nose pad thereby being firmly mounted to the frame body.

3. The glasses frame structure of claim 2, wherein each of the projections has a boss which is clasped between the lenses and the frame body when the lenses are mounted in corresponding grooves of the frame body.

4. The glasses frame structure of claim 1, wherein a cavity is formed on the frame body above the nose pad.

5. The glasses frame structure of claim 1, wherein the nose pad is made of a flexible material.
